(19) United States
(12) Patent Application Publication
(10) Pub. No.: US 2015/0192657 A1
(43) Pub. Date: Jul. 9, 2015

(54) METHOD FOR DETERMINING A POSITION OF A VEHICLE, AND A VEHICLE

(71) Applicant: Audi AG, Ingolstadt (DE)

(72) Inventor: Sebastian Engel, Ingolstadt (DE)

(21) Appl. No.: 14/414,028

(22) PCT Filed: Jun. 12, 2013
(86) PCT No.: PCT/EP2013/001726

§ 371 Date: Jan. 9, 2015

(30) Foreign Application Priority Data
Jul. 13, 2012 (DE) 102012014397.4

(51) Int. Cl. G01S 5/02; G01S 17/48; G01S 19/48; G01S 5/16

(52) U.S. Cl. CPC G01S 5/0284; G01S 5/16; G01S 17/48; G01S 19/48

(57) ABSTRACT

A method for determining a position of a vehicle, in which a sensor is used to detect an object in the surroundings of the vehicle takes into account data values which indicate the location of the object when determining a position of the vehicle relative to the object. In order to determine the relative position of the vehicle, an angle is determined respectively at two different times between a straight line on which the sensor and the object are located, and a reference direction. A length of a distance traveled by the vehicle between these two times is also determined. A vehicle with a position-determining device is also disclosed.

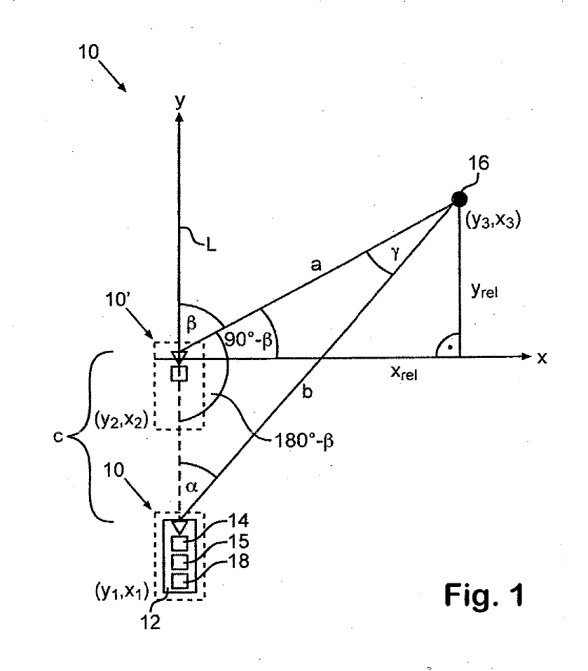

The invention relates to a method for determining a position of a vehicle, wherein a sensor is used to detect an object in a surroundings of the vehicle. A relative position of the vehicle to the object is determined, wherein data values indicating the position of the object are taken into account. Furthermore, the invention relates to a vehicle with a position detecting device.

Many systems now exist in the automotive technology that use GPS (GPS=Global Positioning System, global position determination system) for determining the position of a vehicle. Such systems are, for example, navigation systems or systems for illumination control. In the latter case, for example, the position of headlights of the vehicle can be altered depending on the position of the vehicle on a road, for example when cornering. Likewise, the GPS positioning system is used in the field of vehicle-to-vehicle communication in that the vehicles participating in the communication transmit the respective positions to each other. This helps to prevent accidents.

However, the horizontal deviation between the actual position and the GPS determined position may be 10 m or more due to interference in the position determination. This adversely affects on functions that require a particularly accurate position determination. It is known in this context from the prior art to use objects or distinctive points in the surroundings of the vehicle, whose exact GPS position is known.

For example, DE 10 2008 020 446 A1 describes the correction of a vehicle position by using distinctive points, wherein the measured vehicle position is corrected after such a distinctive point has been identified.

The distinctive points with their associated exact GPS locations are stored in a database in the vehicle. The distinctive point is captured with a camera, and the corresponding exact GPS position is compared with the position measured in the vehicle when the distinctive point has been reached. The measured position is then corrected.

Furthermore, JP 2006 242 731 A discloses a position detecting device which utilizes GPS signals and an object located in the vicinity of the position detecting device. Again, the accuracy of the position determination is here improved based on image analysis.

Objects in the surroundings of the vehicle which are measured with high accuracy and which can be used to improve the determination the GPS position are also referred to as landmarks. By determining the relative position in relation to such a landmark, the position of the vehicle determined by GPS can be corrected and the accuracy of the position determination can be improved. For example, traffic signs or traffic lights can be used as such landmarks. The positions of these landmarks can be measured, for example, by a global positioning system with differential signal (Differential GPS, DGPS) and stored in a database. When a vehicle drives past this landmark at a later time, the GPS location of the vehicle can be more accurately determined and hence improved based on the very accurately measured GPS position of the landmark and the relative distance of the vehicle from the landmark.

However, the relative position of the landmark is difficult to determine with sufficient accuracy. The determination of the relative position of the landmark with sensors currently available in automotive technology, such as a camera or radar, is afflicted with some uncertainty. With respect to the camera, this is due to the fact that the three-dimensional, spatial relations, i.e. the distance of the landmark from the vehicle, can only be imprecisely reconstructed from the two-dimensional camera image. When a radar sensor is used, the lateral position of landmarks is measured imprecisely due to the reflection characteristics.

It is therefore an object of the present invention to provide a method of the aforementioned type as well as a vehicle which allows a determination of the relative position of the vehicle in relation to the object in the surroundings with particularly high accuracy.

This object is attained by a method having the features of claim 1 and by a vehicle having the features of claim 10. Advantageous embodiments with useful developments of the invention are recited in the dependent claims.

In the method according to the invention for determining the position of the vehicle relative to the object in its surroundings at two different times, a respective angle between a straight line on which the sensor and the object are located and a reference direction is determined. Furthermore, a length of a distance traveled by the vehicle between the two times is determined. The vehicle movement that occurred between the two times when the two angles are recorded is thus taken into account for determining the relative positions. This is based on the observation that the angles and the distance traveled by the vehicle can be determined with high accuracy, whereby the relative position can then be determined by using simple, for example trigonometric computations.

The angle to the reference direction, which preferably coincides with the longitudinal axis of the vehicle, can thus be determined very accurately, since the installation site of the sensor in the vehicle and calibration parameters of the sensor are known. Conversely, the projection necessary for determining the relative position of a two-dimensional image captured by a sensor embodied as a camera into a three-dimensional surroundings is quite inaccurate. However, the angle can be very accurately determined from the two-dimensional image of the camera.

The length of the distance traveled by the vehicle between the two times can also be determined with very high accuracy, for example by integrating the number of revolutions of the wheels of the vehicle. Therefore, by taking into account the geometrical parameters that indicate the relative position of the vehicle to the object, the exceptional accuracy with which the position of the object is known can be used to improve the position determination of the vehicle.

In an advantageous embodiment of the invention, a distance of the sensor to the object at the second of the two times is determined based on the angles between the straight line and the reference direction and the distance traveled. When this distance is known, the position of the sensor and hence the position of the vehicle can be particularly accurately determined, since the position of the object provides a highly accurate calibration reference point.

For example, the distance can be calculated based on the relationship

$$a = \frac{sin ( α )}{sin ( β - α )} * c ,$$

wherein a indicates the distance between the sensor and the object at the second time, α indicates the angle between the straight line and the reference direction at the first time, β indicates the angle between the straight line and the reference direction at the second time, and c is the length of the distance traveled. The distance can be calculated particularly fast, accurately and with little effort by applying the sine theorem, using the relationship:

$$\begin{matrix}\frac{a}{c} = \frac{sin ( α )}{sin ( γ )} \\ = \frac{sin ( α )}{sin ( 180 ° - α - ( 180 ° - β ) )} \\ = \frac{sin ( α )}{sin ( β - α )} ,\end{matrix}$$

wherein γ indicates the angle enclosed between the two straight lines obtained at the respective times.

Advantageously, coordinates of the sensor relative to the object may be determined based on the distance between the sensor and the object, because coordinates are particularly well suited for correcting the position of the sensor and hence of the vehicle.

The coordinates are preferably calculated based on the relationships

yᵣₑₗ=α*sin (90°−β), and

xᵣₑₗ=α*cos (90°−β).

Here, yᵣₑₗ is the magnitude of the coordinate of the sensor in the reference direction and the amount xᵣₑₗ is the magnitude of the coordinate of the sensor perpendicular to the reference direction; a is the distance between the sensor and the object at the second time, α is the angle between the straight line and the reference direction at the first time, and β is the angle between the straight line and the reference direction at the second time.

These trigonometric relations can also be used very easily and economically for calculating the coordinates of the sensor relative to the object.

Advantageously, geographical data values indicating the position of the object and geographical data values indicating the position of the vehicle may be transformed into data values of a planar coordinate system, because the coordinates of the sensor relative to the object can be particularly easily reconciled with the data values of the planar coordinate system indicating the position of the object and the position of the vehicle. For example, the UTM-coordinate system (UTM=Universal Transverse Mercator) can be used as a planar coordinate system.

Preferably, those data values of the planar coordinate system that indicate the position of the vehicle are corrected based on the coordinates of the sensor and based on the data values of the planar coordinate system that indicate the position of the object. Thus, the highly precise planar coordinates of the object are utilized to obtain corrected coordinates of the vehicle. This is very easily accomplished computationally.

Preferably, the data values of the planar data system indicating the position of the vehicle are corrected based on the relationship

(yₖₒᵣᵣ,xₖₒᵣᵣ)=(y₃,x₃) (yᵣₑₗ, xᵣₑₗ)

wherein yₖₒᵣᵣ indicates the corrected magnitude of the coordinate of the vehicle in the reference direction, xₖₒᵣᵣ indicates the corrected magnitude of the coordinate of the vehicle perpendicular to the reference direction, y₃ indicates the magnitude of the coordinate of the object in the reference direction, and x₃ indicates the magnitude of the coordinate of the object perpendicular to the reference direction. Corrected GPS coordinates can be obtained very easily from the corrected planar coordinates of the vehicle. The GPS position is thus determined with high accuracy and corrected.

Lastly, the angles determined at the two different times may be derived by evaluating images captured by the sensor embodied as a camera at the two times, because the angle at the respective time can be very easily and accurately determined based on a camera image.

To ensure that the distance traveled between the two times is a straight line, the angle may advantageously be determined at comparatively short successive time intervals. Here, too, the images captured with a camera can advantageously be evaluated because a motion-sensing camera typically takes a picture every 40 ms. When the vehicle is moving, the distance traveled between successive images taken at two capture times is thus substantially straight.

However, depending on the driving speed of the vehicle, another image that is different from the image captured at the second time directly following the capture of an image at the first time may be used to ensure that the two angles are sufficiently and significantly different from each other. At a high driving speed, images captured in immediate succession may thus be used to determine the angles, while at a lower vehicle speed, an image captured a few time intervals later can be used.

The vehicle according to the invention includes a position detecting device for detecting a position of the vehicle. The position detecting device includes a sensor configured to detect an object in a surroundings of the vehicle. Furthermore, the position detecting device also includes a memory device for storing data values indicating the position of the object. A relative position of the vehicle to the object can be determined with an evaluation device of the position detecting device by taking into account the data values indicating the position of the object. For this purpose, the evaluation device is configured to determine at two different times a respective angle between a straight line, on which the sensor and the object are located, and a reference direction. In addition, a length of a distance traveled by the vehicle between the two times can be determined with the evaluation device. The position of the vehicle can be determined with such a position detecting device with very high accuracy, for example by using simple trigonometric calculations. The object in the surroundings of the vehicle is in fact highly accurately measured, with corresponding data values indicating its exact position being stored in the memory device.

The advantages and preferred embodiments described in conjunction with the method according to the invention also apply to the vehicle according to the invention and vice versa.

The aforedescribed features and feature combinations as well as the features and feature combinations mentioned below in the description of the drawing and/or shown only in the FIGURE can not only be used in the respective listed combination, but also in other combinations or severally, without going beyond the scope of the invention.

Further advantages, features and details of the invention will become apparent from the claims, the following description of preferred embodiments and from the drawing.

The drawing shows schematically a vehicle which is moving relative to an object located in the surroundings of the vehicle, wherein the GPS position of the vehicle is corrected based on the movement of the vehicle and based on angles determined at two different times, at which the object is located in each case with reference to the longitudinal axis of the vehicle.

The FIGURE shows schematically a vehicle 10 with a position detecting device 12. A sensor of the position detecting device 12 is embodied here as a camera 14, which takes pictures of the surroundings of the vehicle 10.

An object in form of a so-called landmark 16 is located in the surroundings of the vehicle 10. The location of the landmark 16, which may be for example a traffic sign or a traffic light, has been measured with particularly high accuracy. Data values for this landmark 16, which indicate its position with high accuracy, are therefore known. These data values are presently stored in a memory 15 of the position detecting device 12. In alternative embodiments, the landmark 16 may also transmit these data values to the position detecting device 12, for example wirelessly, via WLAN and the like.

The position detecting device 12 further includes an evaluation device 18, which makes it possible to determine an angle of the landmark 16 with respect to a longitudinal axis of the vehicle L. The evaluation device 18 can be integrated for this purpose, for example, in the camera 14.

An angle α can then be determined with the camera 14 at a first time t₁, which encloses the longitudinal axis of the vehicle L and a straight line, on which the camera 14 and the landmark 16 are located. The FIGURE indicates a section of this straight line that indicates a distance b between the camera 14 and the landmark 16 at the time t₁. The longitudinal axis of the vehicle L indicates a reference direction which preferably coincides with the driving direction in which the vehicle 10 is moving.

Although the angle α can be determined with high accuracy based on the known installation site of the camera 14 in the vehicle 10 and based on the known calibration parameters of the camera 14, the relative position of the vehicle 10 to the landmark 16 cannot be determined with sufficiently high accuracy from the picture captured by the camera 14 at the time when the angle a was determined, because the necessary projection of the two-dimensional image captured by the camera 14 into a three dimensional surroundings is very imprecise.

For this reason, angles between the reference direction indicated by the longitudinal axis of the vehicle L and straight lines on which the camera 14 and the landmark 16 are located are determined at two different times t₁, t₂. At the time t₁, the vehicle 10 is located at a position having coordinates y₁, x₁. This position may be, for example, the GPS location of the vehicle 10, which was transformed by a coordinate transformation into a planar coordinate system, for example into the UTM coordinate system. At a time t₂, the vehicle 10′ has traveled a certain distance in the reference direction, wherein a length c of this distance traveled is indicated in the FIGURE.

At the time t₂, the vehicle 10′ is hence located at a position having the coordinates y₂, x₂. At this time t₂, an angle β is once more determined, which encloses a straight line on which the camera 14 and the landmark 16 are located and the longitudinal axis Of the vehicle L. In addition, the length c of the distance traveled is known in the vehicle 10′, i.e. the distance traveled by the vehicle 10 between the time t₁ and the time t₂. The length c can be determined, for example, by integrating the number of revolutions of a wheel of the vehicle 10.

In the FIGURE, a distance representing the distance between the vehicle 10′ and the landmark 16 at the time t₂ is designated with a. This distance a at the time t₂ can be determined by applying the sine theorem based on the following relationships:

$$\begin{matrix}\frac{a}{c} = \frac{sin ( α )}{sin ( γ )} \\ = \frac{sin ( α )}{sin ( 180 ° - α - ( 180 ° - β ) )} \\ = \frac{sin ( α )}{sin ( β - α )} ,\end{matrix}$$

wherein γ is the angle between the distance a of the vehicle 10′ to the landmark 16 at the time t₂ and the distance b of the vehicle 10 to the landmark 16 at the time t₁. Accordingly, the angle having the value 180°-β is an angle in a triangle having the sides a, b, and c and the other angles α and γ.

The relative position of the vehicle 10′ to the landmark 16 at the time t₂ can now be determined by using sine and cosine relationships, such as the relationships:

yᵣₑₗ=α*sin (90°−β), and

xᵣₑₗ=α*cos (90°−β).

In a further step, the corrected GPS position of the vehicle 10′ is now calculated from the known and highly accurate GPS position of the landmark 16 and the coordinates yᵣₑₗ and xᵣₑₗ indicating the relative position of the vehicle 10′ to the landmark. This is performed, for example, as follows:

First, the highly accurate GPS position of the landmark 16 is transformed into planar coordinates, such as the UTM coordinates. Thereafter, the distances yᵣₑₗ and xᵣₑₗ are subtracted from the planar UTM coordinates of the landmark 16, i.e. coordinates x₃, y₃. This yields corrected UTM coordinates of the vehicle 10′ at the time t₂:

(yₖₒᵣᵣ,xₖₒᵣᵣ)=(y₃,x₃)−(yᵣₑₗ,xᵣₑₗ)

The corrected planar UTM coordinates yₖₒᵣᵣ and xₖₒᵣᵣ of the vehicle 10′ are then converted into GPS coordinates. The GPS position of the vehicle 10′ at the time t₂ is thus determined with high accuracy and corrected.

The afore-described trigonometric calculations and the transformation of the GPS position into planar coordinates and vice versa can be performed by the evaluation device 18 of the position detecting device 12. In particular, provided that an evaluation device of the camera 14 is used for determining the angles α, β, a separate evaluation device 18 may be used in addition to the evaluation device 14 of the camera.

1-10. (canceled)

11. A method for determining a position of a vehicle, comprising:
detecting with a sensor an object in a surroundings of the vehicle, and
determining a relative position of the vehicle to the object by taking into account data values indicating a location of the object,
wherein the relative position of the vehicle is determined at two different times from a respective angle enclosed between a straight line, on which the sensor and the object are located, and a reference direction, as well as from a length of a distance traveled by the vehicle between the two different times.

12. The method of claim 11, further comprising
determining a distance between the sensor and the object at a second of the two different times based on the angles enclosed at the two different times between the straight line and the reference direction and based on the length of the distance traveled.

13. The method of claim 12, wherein the distance between the sensor and the object is calculated from the relationship
$$a = \frac{sin ( α )}{sin ( β - α )} * c ,$$
with
a=distance between the sensor and the object at the second time,
α=angle between the straight line and the reference direction at a first time,
β=angle between the straight line and the reference direction at the second time, and
c=length of the distance traveled.

14. The method of claim 12, further comprising
determining coordinates of the sensor relative to the object are based on the distance between the sensor and the object.

15. The method of claim 14, wherein the coordinates are calculated using the relationships
yᵣₑₗ=α*sin (90°−β), and
xᵣₑₗ=α*cos (90°−β), with
yᵣₑₗ=magnitude of a coordinate of the sensor in the reference direction (L),
xᵣₑₗ=magnitude of the coordinate of the sensor perpendicular to the reference direction (L),
a=distance between the sensor and the object at the second time,
α=angle between the straight line and the reference direction at the first time,
β=angle between the straight line and the reference direction at the second time.

16. The method of claim 14, further comprising
transforming geographical data values indicating the location of the object and geographical data values indicating the position of the vehicle into data values of a planar coordinate system.

17. The method of claim 16,
characterized in that
based on the coordinates of the sensor and based on the data values of the planar coordinate system that indicate the location of the object, correcting those data values of the planar coordinate system that indicate the position of the vehicle.

18. The method of claim 17, wherein the data values of the planar coordinate system that indicate the position of the vehicle are corrected based on the relationship
(yₖₒᵣᵣ, xₖₒᵣᵣ)=(y₃,x₃)−(yᵣₑₗ,xᵣₑₗ), with
yₖₒᵣᵣ=corrected magnitude of the coordinate of the vehicle the reference direction,
xₖₒᵣᵣ=corrected magnitude of the coordinate of the vehicle perpendicular to the reference direction,
y₃=magnitude of the coordinate of the object in the reference direction,
x₃=magnitude of the coordinate of the object perpendicular to the reference direction.

19. The method of claim 11, wherein the angles determined at the two different times are determined by evaluating images captured by the sensor embodied as a camera at the two different times.

20. A vehicle comprising with a position detecting device for determining a
position of the vehicle, the position detecting device comprising: a sensor configured to capture an object in a surroundings of the vehicle, a memory device storing data values indicating a location of the object, and an evaluation device configured to determine a relative position of the vehicle to the object by taking into
consideration the data values indicating the location of the object,
to determine at two different times a respective angle enclosed between a straight line, on which the sensor and the object are located, and a reference direction, and
to determine a length of a distance traveled by the vehicle between the two different times.
